(19) United States
(12) Patent Application Publication
(10) Pub. No.: US 2018/0077375 A1
(43) Pub. Date: Mar. 15, 2018

(54) DISPLAY APPARATUS AND METHOD FOR SETTING REMOTE CONTROL APPARATUS USING THE DISPLAY APPARATUS

(71) Applicant: Samsung Electronics Co., Ltd., Suwon-si (KR)

(72) Inventors: Won-jae LEE, Seoul (KR); Jong-jin Park, Suwon-si (KR)

(73) Assignee: Samsung Electronics Co., Ltd., Suwon-si (KR)

(21) Appl. No.: 15/699,136

(22) Filed: Sep. 8, 2017

(30) Foreign Application Priority Data
Sep. 9, 2016 (KR) 10-2016-0116350

(51) Int. Cl. H04N 5/44; H04N 5/60

(52) U.S. Cl. CPC H04N 5/4403; H04N 5/60; H04N 2005/4432; H04N 2005/4435; H04N 2005/443; H04N 2005/4426; H04N 2005/4428

(57) ABSTRACT

A display apparatus is disclosed, which includes a storage configured to store a plurality of code sets, a communicator configured to perform communication with a remote control apparatus having a microphone, an interface connected to an audio output apparatus and configured to transmit an audio signal to the audio output apparatus, and a processor configured to transmit one of the plurality of code sets to the remote control apparatus while the audio output apparatus is outputting the audio signal, and in response to an audio signal received at the remote control apparatus through the microphone being received from the remote control apparatus, determine whether the code set transmitted to the remote control apparatus is a code set capable of controlling the audio output apparatus by determining whether the audio output apparatus is outputting the audio signal based on the received audio signal.

### CROSS-REFERENCE TO RELATED APPLICATIONS

This application claims priority from Korean Patent Application No. 10-2016-0116350, filed on Sep. 9, 2016 in the Korean Intellectual Property Office, the disclosure of which is incorporated herein by reference in its entirety.

### BACKGROUND

### 1. Field of the Invention

Apparatuses and methods consistent with what is disclosed herein relate to a display apparatus and a method for setting a remote control apparatus using the display apparatus, and more particularly, to a display apparatus for setting a remote control apparatus and a method for setting a remote control apparatus using the display apparatus.

### 2. Description of the Related Art

With the recent development of electronic technology, many electronic devices are installed in homes, and in order to provide convenience to user, these electronic devices are provided with the remote control apparatus for controlling thereof.

In the situation mentioned above, a user has multiple remote control apparatuses corresponding to the number of electronic devices, which is inconvenient for the user since he or she has to operate a plurality of remote control apparatus alternately.

Accordingly, a remote control apparatus has been developed, which allows a user to control a plurality of electronic devices through one single remote control apparatus. However, in this case, the user still has inconvenience of having to manually set an electronic device to be controlled.

Accordingly, it is necessary to provide an easier method for setting an electronic device to be controlled.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

The present disclosure is based on the need mentioned above, and it is an object of the present disclosure to provide a display apparatus for setting a remote control apparatus and a method for setting a remote control apparatus using the display apparatus, in which a code set capable of controlling an audio output apparatus is determined based on an output state of the audio output apparatus receiving a mute signal from the remote control apparatus and the remote control apparatus is set accordingly.

According to an aspect of the present disclosure, there is provided a display apparatus including a storage configured to store a plurality of code sets, a communicator configured to perform communication with a remote control apparatus having a microphone, an interface connected to an audio output apparatus and configured to transmit an audio signal to the audio output apparatus, and a processor configured to transmit one of the plurality of code sets to the remote control apparatus while the audio output apparatus is outputting the audio signal, and in response to an audio signal received at the remote control apparatus through the microphone being received from the remote control apparatus, determine whether or not the code set transmitted to the remote control apparatus is a code set capable of controlling the audio output apparatus by determining whether the audio output apparatus is outputting the audio signal based on the received audio signal.

Further, if the audio output apparatus is not outputting the audio signal, the processor may determine that the code set transmitted to the remote control apparatus is a code set for controlling the audio output apparatus.

Further, if the audio output apparatus is outputting the audio signal, the processor may transmit another one of the plurality of code sets to the remote control apparatus, and in response to an audio signal received at the remote control apparatus through the microphone being received from the remote control apparatus, the processor may determine whether or not the code set transmitted to the remote control apparatus is a code set capable of controlling the audio output apparatus by determining whether the audio output apparatus is outputting the audio signal based on the received audio signal.

Meanwhile, the processor may add a test tone signal to an audio signal transmitted to the audio output apparatus.

In one example, after transmitting the code set to the remote control apparatus, the processor may determine whether the audio output apparatus is outputting the audio signal or not based on whether the test tone signal is included in the audio signal received from the remote control apparatus.

Meanwhile, a method for setting a remote control apparatus of a display apparatus is provided, in which the display apparatus is connected to an audio output apparatus and configured to perform communication with the remote control apparatus having a microphone, and the method may include transmitting an audio signal to the audio output apparatus, transmitting one of a plurality of code sets to the remote control apparatus while the audio output apparatus is outputting the audio signal, and in response to receiving an audio signal received at the remote control apparatus through the microphone from the remote control apparatus, determining whether the code set transmitted to the remote control apparatus is a code set capable of controlling the audio output apparatus by determining whether the audio output apparatus is outputting the audio signal based on the received audio signal.

Further, when the determining if the audio output apparatus is not outputting the audio signal, the method may include determining that the code set transmitted to the remote control apparatus is a code set for controlling the audio output apparatus.

In addition, the method for setting according to the present embodiment may further include, if the audio output apparatus is outputting the audio signal, transmitting another one of the plurality of code sets to the remote control apparatus, and in response to receiving an audio signal received at the remote control apparatus through the microphone from the remote control apparatus, determining whether the code set transmitted to the remote control apparatus is a code set capable of controlling the audio output apparatus by determining whether the audio output apparatus is outputting the audio signal based on the received audio signal.

Meanwhile, the transmitting the audio signal may include adding a test tone signal to the audio signal transmitted to the audio output apparatus.

In one example, the method for setting according to the present embodiment may further include, after transmitting the code set to the remote control apparatus, determining whether the audio output apparatus is outputting the audio signal based on whether the test tone signal is included in the audio signal received from the remote control apparatus.

Meanwhile, an audio system including a display apparatus, an audio output apparatus and a remote control apparatus is provided, in which the audio output apparatus is configured to output an audio signal received from the display apparatus, the display apparatus is configured to transmit one of a plurality of code sets to the remote control apparatus while the audio output apparatus is outputting the audio signal, the remote control apparatus has a microphone and is configured to transmit a control signal based on the code set received from the display apparatus to the audio output apparatus, and after the remote control apparatus transmits the control signal, in response to receiving an audio signal received through the microphone from the remote control apparatus, the display apparatus determines whether the code set transmitted to the remote control apparatus is a code set capable of controlling the audio output apparatus by determining whether the audio output apparatus is outputting the audio signal based on the received audio signal.

According to various embodiments of the present disclosure as described above, the remote control apparatus may be set to control the audio output apparatus without requiring any additional operation from the user, and therefore, convenience can be improved.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a view provided to explain an audio system according to an embodiment of the present disclosure;

FIG. 2 is a block diagram provided to explain a configuration of a display apparatus according to an embodiment of the present disclosure;

FIG. 3 is a block diagram provided to explain a configuration of a remote control apparatus according to an embodiment of the present disclosure;

FIG. 4 is a view provided to explain a method of detecting a code set according to an embodiment of the present disclosure;

FIG. 5 is a block diagram provided to explain a detailed configuration of a display apparatus according to an embodiment of the present disclosure; and

FIG. 6 is a view provided to explain a setting method according to an embodiment of the present disclosure.

### DETAILED DESCRIPTION OF EXEMPLARY EMBODIMENTS

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Certain exemplary embodiments of the present inventive concept will now be described in greater detail with reference to the accompanying drawings.

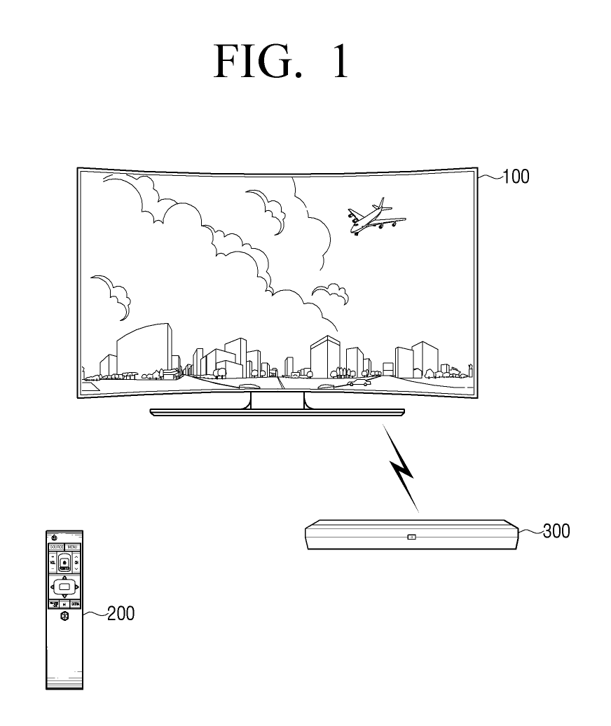

FIG. 1 is a view provided to explain an audio system according to an embodiment of the present disclosure.

Referring to FIG. 1, an audio system 1000 includes a display apparatus 100, a remote control apparatus 200, and an audio output apparatus 300.

The display apparatus 100 is connected to the audio output apparatus 300. For example, the display apparatus 100 and the audio output apparatus 300 may be connected to each other through an optical cable, an RCA cable, or an AUX cable and so on.

Accordingly, the display apparatus 100 may transmit an audio signal to the audio output apparatus 300, and the audio output apparatus 300 may output the audio signal received from the display apparatus 100.

The display apparatus 100 performing the functions mentioned above may be implemented as a TV, and the audio output apparatus 300 may be implemented as a speaker. However, it should be understood that this is merely an example, and the display apparatus 100 and the audio output apparatus 300 may be implemented as various types of apparatuses capable of transmitting audio signals and outputting the received audio signals.

The remote control apparatus 200 may control the display apparatus 100. Specifically, the remote control apparatus 200 may be implemented as a remote control for controlling the display apparatus 100 as a main device, and may transmit, to the display apparatus 100 in an IR manner, a control signal for turning on/off or performing channel controlling, volume controlling, and so on based on a code set previously set in the remote control apparatus 200.

The remote control apparatus 200 may perform communication with the display apparatus 100 to control the display apparatus 100 and transmit and receive various data to and from the display apparatus 100. For example, the remote control apparatus 200 may perform communication with the display apparatus 100 according to the Bluetooth method.

Meanwhile, the remote control apparatus 200 may control the audio output apparatus 300.

However, in this case, because the remote control apparatus 200 is configured to control the display apparatus 100 as a main device, the remote control apparatus 200 has to be additionally set based on a code set that can control the audio output apparatus 300 so as to be able to control the audio output apparatus 300.

In one example, the code set may include various information on the control signal capable of controlling the audio output apparatus. For example, the code set may include information on a format, a custom code, a key code, and so on of a control signal that is capable of controlling the audio output apparatus.

Meanwhile, the format (e.g., TC9012, NEC, etc.) of the control signal capable of controlling the audio output apparatus may be the same or different from to each other for different manufacturers. In addition, a manufacturer allocates a custom code for each type of electronic device to classify the electronic devices manufactured by the manufacturer, and the custom codes allocated to the audio output apparatus may be the same or different for different manufacturers. In addition, even the same manufacturer may have varying key codes for performing a specific function for different models.

Therefore, when the remote control apparatus 200 is set through a specific code set, the remote control apparatus 200 is able to control only a specific model of the audio output apparatus of a specific manufacturer that corresponds to that code set.

Specifically, when a button provided on the remote control apparatus 200 is selected, the remote control apparatus 200 generates an IR-type control signal including a custom code and a key code corresponding to the selected button based on the code set in a format used at the specific model of audio output apparatus of the specific manufacturer and transmits the generated control signal to the audio output apparatus 300.

In this case, when the audio output apparatus 300 determines that the control signal received from the remote control apparatus 200 is a control signal corresponding to itself, that is, a signal capable of controlling the audio output apparatus 300 itself, the audio output apparatus 300 performs an operation corresponding to the control signal.

That is, the audio output apparatus 300 may be already stored with the information on the format, the custom code, and the key code of the control signal defined by the manufacturer, and when the control signal is received from the remote control apparatus 200, the audio output apparatus 300 may determine whether the received control signal is a control signal capable of controlling the audio output apparatus 300 itself, using the custom code according to format predefined by manufacturer, and when the received control signal corresponds to a control signal capable of controlling the audio output apparatus 300, the audio output apparatus 300 may detect the key code from the control signal and perform the operation corresponding to the detected key code.

Therefore, in order to control the audio output apparatus 300, the remote control apparatus 200 has to be set based on a code set corresponding to the audio output apparatus 300.

Hereinafter, a method for setting the remote control apparatus 200, which detects a code set corresponding to the audio output apparatus 300 and sets the remote control apparatus 200 so as to control the audio output apparatus 300, will be described in more detail.

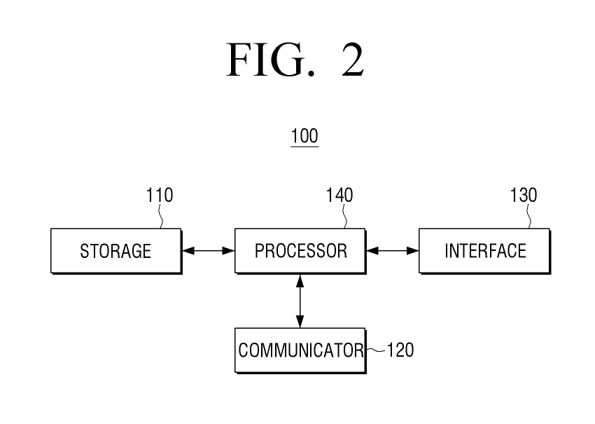

FIG. 2 is a block diagram provided to explain a configuration of a display apparatus according to an embodiment of the present disclosure.

Referring to FIG. 2, the display apparatus 100 may include a storage 110, a communicator 120, an interface 130, and a processor 140.

The storage 110 stores a plurality of code sets. In one example, the code set may include various information on the control signal capable of controlling the audio output apparatus.

For example, the code set may include information about the control signal capable of controlling a specific model of audio output apparatus manufactured by a specific manufacturer, such as, the format of the control signal, the number of bits of the custom code and key code in that format, high-level and low-level duration of each bit, and so on.

That is, because the format, the custom code, and the key code and so on of the control signal capable of controlling the audio output apparatus may differ from each other depending on at least one of the manufacturer and the model of the audio output apparatus, the storage 110 may be already stored with a plurality of code sets for various models of audio output apparatuses of different manufacturers.

To this end, the storage 110 may be implemented as various storage media such as a hard disk, a non-volatile memory, a volatile memory, and so on.

The communicator 120 performs communication with the remote control apparatus 200. For example, the communicator 120 may include a chip, and so on for performing Bluetooth communication to communicate with the remote control apparatus 200 according to Bluetooth communication method. However, it should be understood that this is merely an example, and communication with the remote control apparatus 200 may be performed in various ways.

The interface 130 is connected to the audio output apparatus 300 and transmits the audio signal to the audio output apparatus 300.

For example, the interface 130 may be connected to the audio output apparatus 300 through an optical cable, an RCA cable, or an AUX cable and so on, including various types of output ports. However, it should be understood that this is only an example and that the interface may be connected to the audio output apparatus 300 in various ways.

The processor 140 controls the overall operation of the display apparatus 100. To this end, the processor 140 including a central processing unit (CPU), a random access memory (RAM), and a read only memory (ROM) may perform computation or data processing relating to control of other components included in the display apparatus 100.

First, the processor 140 may control the communicator 120 to perform communication with the remote control apparatus 200. For example, the processor 140 may control the communicator 120 to connect to the remote control apparatus 200 according to the Bluetooth communication method.

In addition, the processor 140 may control the interface 130 to output the audio signal to the audio output apparatus 300.

In one example, the audio signal may be an audio signal for various contents such as a broadcast program, etc.

In this case, the processor 140 may add a test tone signal to the audio signal transmitted to the audio output apparatus 300.

In one example, the test tone signal is a watermarking signal for indicating that the audio signal is outputted from the audio output apparatus 300, and the processor 140 may add the test tone signal to the audio signal in various ways.

For example, the processor 140 may add a signal of a specific size having a predetermined time difference at a specific frequency to an audio signal, or add a signal having a specific size at a specific frequency to the audio signal, or add the first signal having a specific size at a specific frequency and a second signal having a different size at a different frequency from the first signal to the audio signal.

In this case, the test tone signal may be added in the frequency bands of the audible and inaudible regions.

However, it should be understood that this is merely an example, and the test tone signal may be implemented in various ways.

Meanwhile, the audio output apparatus 300 may be implemented as a speaker, etc. and may output an audio signal received from the display apparatus 100. Accordingly, the audio output apparatus 300 may output the audio signal to which the test tone signal is added.

Meanwhile, the processor 140 may control the communicator 120 to transmit one of a plurality of code sets to the remote control apparatus 200 while the audio output apparatus 300 is outputting the audio signal.

In this case, when a code set is received from the display apparatus 100, the remote control apparatus 200 may transmit a mute signal based on the received code set to the audio output apparatus 300.

That is, based on the received code set, the remote control apparatus 200 may transmit a control signal including the key code corresponding to the mute function to the audio output apparatus 300.

Specifically, based on the received code set, the remote control apparatus 200 may generate an IR-type control signal including a custom code and a key code corresponding to a mute function in a format used at the specific model of audio output apparatus of the specific manufacturer and transmit the generated control signal to the audio output apparatus 300.

Accordingly, the audio output apparatus 300 determines whether the control signal received from the remote control apparatus 200 is a control signal capable of controlling the audio output apparatus 300 itself based on the custom code according to the format of the control signal, and when the control signal received from the remote control apparatus 200 corresponds to a control signal capable of controlling the audio output apparatus 300 itself, the audio output apparatus 300 may stop outputting the audio signal according to a key code corresponding to the mute function.

However, when the control signal received from the remote control apparatus 200 does not correspond to the control signal capable of controlling the audio output apparatus 300 itself, the audio output apparatus 300 continues outputting the audio signal without performing any separate operation.

Thereafter, when the remote control apparatus 200 receives an audio signal received at the remote control apparatus 200 through the microphone from the remote control apparatus 200, the processor 140 may determine whether the audio output apparatus 300 is outputting an audio signal or not based on the received signal and determine whether or not the code set transmitted to the remote control apparatus 200 is a code set capable of controlling the audio output apparatus 300.

Specifically, after transmitting a mute signal based on the code set to the audio output apparatus 300, the remote control apparatus 200 may then collect the audio signal through the microphone.

In this case, when the audio output apparatus 300 stops outputting the audio according to the mute signal received from the remote control apparatus 200, the audio signal outputted from the audio output apparatus 300 is not included in the audio signal collected through the microphone. However, when the audio output apparatus 300 does not stop outputting the audio, the audio signal outputted from the audio output apparatus 300 may be included in the audio signal collected through the microphone.

Accordingly, after transmitting the code set to the remote control apparatus 200, the processor 140 may determine whether the audio output apparatus 300 is outputting the audio signal or not based on whether or not the test tone signal is present in the audio signal received from the remote control apparatus 200.

That is, when the test tone signal is detected from the audio signal received from the remote control apparatus 200, the processor 140 may determine that the audio signal outputted from the audio output apparatus 300 is present in the audio signal received from the remote control apparatus 200, and, as a result, the processor 140 may determine that the audio output apparatus 300 is outputting the audio signal.

However, when the test tone signal is not detected from the audio signal received from the remote control apparatus 200, the processor 140 may determine that the audio signal outputted from the audio output apparatus 300 is not present in the audio signal received from the remote control apparatus 200, and, as a result, the processor 140 may determine that the audio output apparatus 300 is not outputting the audio signal.

In this manner, the test tone signal is used to distinguish the audio signal outputted from the audio output apparatus 300 from an audio signal from ambient noise, since an audio signal may be present due to ambient noise when the remote control apparatus 200 collects an audio signal through the microphone,

Meanwhile, when it is determined that the audio output apparatus 300 is not outputting the audio signal, the processor 140 may determine that the code set transmitted to the remote control apparatus 200 is a code set capable of controlling the audio output apparatus 300.

In this case, the processor 140 may control the communicator 120 to transmit a control command to the remote control apparatus 200 so that the remote control apparatus 200 is set according to the received code set.

In addition, the processor 140 may transmit the audio signal to the audio output apparatus 300 without adding a test tone signal to the audio signal based on the fact that a code set capable of controlling the audio output apparatus 300 has been detected.

However, when it is determined that the audio output apparatus 300 is outputting an audio signal, the processor 140 may control the communicator 120 to transmit another one of a plurality of code sets to the remote control apparatus 200.

In this case, when the remote control apparatus 200 receives another code set from the display apparatus 100, the remote control apparatus 200 may transmit a mute signal based on the received another code set to the audio output apparatus 300.

In addition, after transmitting a mute signal based on another code set to the audio output apparatus 300, the remote control apparatus 200 may collect the audio signal through the microphone and transmit the audio signal to the display apparatus 100.

Meanwhile, when the remote control apparatus 200 receives an audio signal received at the remote control apparatus 200 through the microphone from the remote control apparatus 200, the processor 140 may determine whether the audio output apparatus 300 is outputting an audio signal or not based on the received audio signal and determine whether or not another code set transmitted to the remote control apparatus 200 is a code set capable of controlling the audio output apparatus 300.

That is, the processor 140 may determines whether or not the audio signal outputted from the audio output apparatus 300 is present in the signal received from the remote control apparatus 200 and determine the output state of the audio output apparatus 300 according to the presence or absence of the audio signal.

Accordingly, when it is determined that the audio output apparatus 300 is not outputting the audio signal, the processor 140 may determine that another code set transmitted to the remote control apparatus 200 is a code set capable of controlling the audio output apparatus 300.

In this case, the processor 140 may control the communicator 120 to transmit a control command to the remote control apparatus 200 so that the remote control apparatus 200 is set according to the received another code set.

In addition, the processor 140 may transmit the audio signal to the audio output apparatus 300 without adding a test tone signal to the audio signal based on the fact that a code set capable of controlling the audio output apparatus 300 has been detected.

However, when it is determined that the audio output apparatus 300 is outputting an audio signal, the processor 140 may control the communicator 120 to transmit yet another one of a plurality of code sets to the remote control apparatus 200.

Accordingly, the processor 140 may repeat the process described above such that a code set capable of controlling the audio output apparatus 300 is detected and the remote control apparatus 200 is set with the code set capable of controlling the audio output apparatus 300.

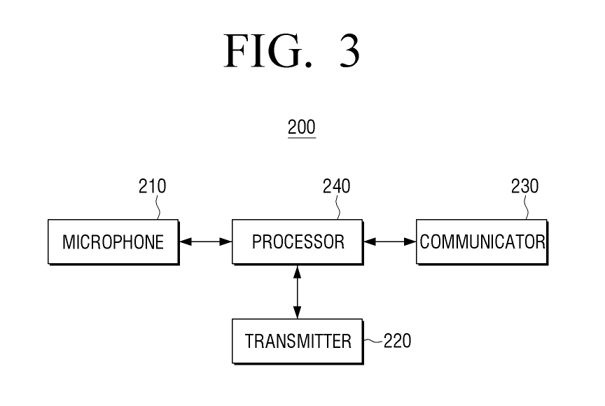

FIG. 3 is a block diagram provided to explain a configuration of a remote control apparatus according to an embodiment of the present disclosure.

Referring to FIG. 3, the remote control apparatus 200 may include a microphone 210, a transmitter 220, a communicator 230, and a processor 240.

The microphone 210 receives an audio signal. Specifically, the microphone 210 may collect an audio signal generated around the remote control apparatus 200.

The transmitter 220 transmits a control signal to the audio output apparatus 300. For example, the transmitter 220 may transmit the control signal generated according to the code set to the audio output apparatus 300 in an IR manner.

The communicator 230 performs communication with the display apparatus 100. For example, the communicator 230 may include a chip, and so on for performing Bluetooth communication to communicate with the display apparatus 100 according to Bluetooth communication method. However, it should be understood that this is merely an example, and communication with the display apparatus 100 may be performed in various ways.

The processor 240 controls the overall operation of the remote control apparatus 200. To this end, the processor 240 including a central processing unit (CPU), a random access memory (RAM), and a read only memory (ROM) may perform computation or data processing relating to control of other components included in the remote control apparatus 200.

First, the processor 240 may control the communicator 230 to perform communication with the display apparatus 100. For example, the processor 240 may control the communicator 230 to connect to the display apparatus 100 according to the Bluetooth communication method.

Further, when the code set is received from the display apparatus 100, the processor 230 may control the transmitter 220 to transmit a mute signal based on the code set to the audio output apparatus 300.

Specifically, based on the code set received from the display apparatus 100, the processor 230 may generate an IR-type control signal including a custom code and a key code corresponding to a mute function in a format used at the specific model of audio output apparatus of the specific manufacturer and transmit the generated control signal to the audio output apparatus 300 through the transmitter 220.

Meanwhile, after transmitting a mute signal based on the code set to the audio output apparatus 300, the processor 240 may control the communicator 220 to collect the audio signal through the microphone 210 and output the audio signal collected through the microphone 210 to the display apparatus 100.

Thereafter, when a control command for setting the remote control apparatus 200 according to the code set is received from the display apparatus 100, the processor 240 may control so that the remote control apparatus 200 is set according to the code set.

Accordingly, when a button provided on the remote control apparatus 200 is selected, based on the code set, the processor 240 may generate an IR-type control signal including the custom code and the key code assigned to the selected button in a format used at the specific model of audio output apparatus of the specific manufacturer and transmits the generated control signal to the audio output apparatus 300 through the communicator 220.

Meanwhile, when another code set is received from the display apparatus 100 after transmitting a mute signal to the audio output apparatus 300, the processor 240 may control the transmitter 220 to transmit a mute signal based on another code set to the audio output apparatus 300.

In addition, after transmitting a mute signal based on another code set to the audio output apparatus 300, the processor 240 may control the communicator 220 to collect the audio signal through the microphone 210 and output the audio signal collected through the microphone 210 to the display apparatus 100.

Thereafter, when a control command for setting the remote control apparatus 200 according to another code set is received from the display apparatus 100, the processor 240 may control so that the remote control apparatus 200 is set according to another code set.

In the manner described above, the processor 240 may repeat the process described above until a control command for setting according to the code set is received, such that the remote control apparatus 200 may be set to control the audio output apparatus 300.

Meanwhile, in the example described above, it was exemplified that the display device 100 transmits one of a plurality of code sets to the remote control device 200, and then receives the audio signal from the remote control device 200 and determines the state of the audio output device 300 based on the received audio signal.

However, this is merely an example. Accordingly, in another embodiment, the remote control apparatus 200 may receive the audio signal through the microphone and transmit the received audio signal to the display apparatus 100, prior to receiving the code set from the display apparatus 100.

In this case, the display apparatus 100 may transmit one of a plurality of code sets to the remote control apparatus 200 after the audio signal is received from the remote control apparatus 200.

Specifically, when the audio signal is received from the remote control apparatus 200, the display apparatus 100 may determine whether or not a test tone signal is present in the audio signal received from the remote control apparatus 200 and transmit one of a plurality of code sets to the remote control apparatus 200 when the test tone signal is present.

In this manner, the display apparatus 100 may transmit the code set to the remote control apparatus 200 after determining that the audio output apparatus 300 is outputting the audio signal.

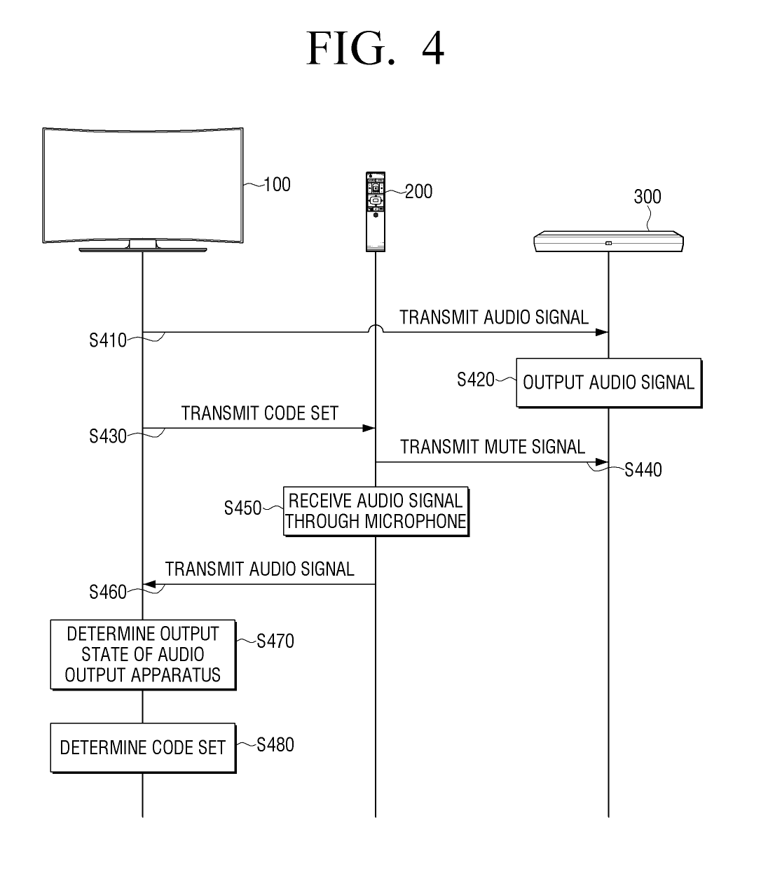

FIG. 4 is a sequence diagram illustrating a method for setting a remote control apparatus according to an embodiment of the present disclosure.

Referring to FIG. 4, first, the display apparatus 100 transmits an audio signal to the audio output apparatus 300, at S410. In this case, the display apparatus 100 may add a test tone signal to the audio signal and transmit the resultant signal to the audio output apparatus 300.

Meanwhile, the audio output apparatus 300 outputs the audio signal received from the display apparatus 100, at S420.

Thereafter, the display apparatus 100 transmits one of a plurality of code sets to the remote control apparatus 200, at S430.

In this case, the remote control apparatus 200 generates a mute signal based on the code set using the code set received from the display apparatus 100, and transmits a resultant signal to the audio output apparatus 300, at S440.

Thereafter, the remote control apparatus 200 collects the audio signal generated through the microphone, at S450, and transmits the audio signal to the display apparatus 100, at S460.

Accordingly, the display apparatus 100 determines whether or not the audio signal outputted from the audio output apparatus 300 is present in the audio signal received from the remote control apparatus 200 and determines the output state of the audio output apparatus 300, at S470.

In addition, the display apparatus 100 determines a code set based on the output state of the audio output apparatus 300, at S480.

Specifically, when the test tone signal is not present in the audio signal received from the remote control apparatus 200, the display apparatus 100 may determine that the audio signal outputted from the audio output apparatus 300 is not present in the audio signal received from the remote control apparatus 200, and as a result, the display apparatus 100 may determine that the audio output apparatus 300 has stopped outputting the audio signal.

In this case, the display apparatus 100 may determine that the code set transmitted to the remote control apparatus 200 corresponds to a code set capable of controlling the audio output apparatus 300 and transmit a setting command according to code set to the remote control apparatus 200. Accordingly, the remote control apparatus 200 may be set to be able to control the audio output apparatus 300.

However, when the test tone signal is present in the audio signal received from the remote control apparatus 200, the display apparatus 100 may determine that the audio signal outputted from the audio output apparatus 300 is present in the audio signal received from the remote control apparatus 200, and, as a result, the display apparatus 100 may determine that the audio output apparatus 300 has not stopped outputting the audio signal.

In this case, the process described above may be repeated until a code set among a plurality of code sets, which is capable of controlling the audio output apparatus 300, is detected.

In this manner, the audio output apparatus 300 may output the audio signal received from the display apparatus 100, and the display apparatus 100 may transmit one of a plurality of code sets to the remote control apparatus 200 while the audio output apparatus 300 is outputting the audio signal, and the remote control apparatus 200 having the microphone may transmit the control signal based on the code set received from the display apparatus 100 to the audio output apparatus 300. In this example, when an audio signal is received through the microphone from the remote control apparatus 200 after the remote control apparatus 200 transmits the control signal, the display apparatus 100 may determine whether or not the audio output apparatus 300 is outputting an audio signal based on the received audio signal to determine whether or not the code set transmitted to the remote control apparatus 200 is a code set capable of controlling the audio output apparatus 300.

Meanwhile, in the example described above, the display apparatus 100 determines the output state of the audio output apparatus 300 based on the audio signal received from the remote control apparatus 200, but this is merely an example.

Accordingly, rather than transmitting the audio signal received through the microphone to the display apparatus 100, the remote control apparatus 200 may directly determine the output state of the audio output apparatus 300 based on the audio signal received through the microphone.

Specifically, when the code set is received from the display apparatus 100, the processor 240 may control the transmitter 220 to transmit a mute signal based on the code set to the audio output apparatus 300.

Thereafter, after the processor 240 transmits the mute signal based on the code set to the audio output apparatus 300, the processor 240 may collect the audio signal through the microphone 210, and determine whether the audio signal outputted from the apparatus 300 is present in the audio signal received through the microphone 210 to determine whether the audio output apparatus 300 is outputting the audio signal.

In this case, the remote control apparatus 200 may be provided with information on the test tone signal from the display apparatus 100.

Specifically, when the test tone signal is detected from the audio signal received through the microphone 210, the processor 240 may determine that the audio signal outputted from the audio output apparatus 300 is present in the audio signal received through the microphone 210, and, as a result, the processor 240 may determine that the audio output apparatus 300 is outputting the audio signal.

However, when the test tone signal is not detected from the audio signal received through the microphone 210, the processor 240 may determine that the audio signal outputted from the audio output apparatus 300 is not present in the audio signal received through the microphone 210, and, as a result, the processor 240 may determine that the audio output apparatus 300 is not outputting the audio signal.

Meanwhile, when it is determined that the audio output apparatus 300 is not outputting the audio signal, the processor 240 may determine that the code set received from the display apparatus 100 is a code set capable of controlling the audio output apparatus 300.

In this case, the processor 240 may set the remote control apparatus 200 according to the code set received from the display apparatus 100, and transmit, to the display apparatus 100 through the communicator 220, a message indicating that the remote control apparatus 200 is set with the code set capable of controlling the audio output apparatus 300.

Accordingly, the processor 140 may determine that the remote control apparatus 200 is finished with setting, and therefore, may not transmit the code set to the remote control apparatus 200. In addition, the processor 140 may transmit the audio signal to the audio output apparatus 300 without adding a test tone signal to the audio signal based on the fact that a code set capable of controlling the audio output apparatus 300 is detected.

Meanwhile, when it is determined that the audio output apparatus 300 is outputting the audio signal, the processor 240 may request the display apparatus 100 to transmit another code set.

Accordingly, when receiving from the remote control apparatus 200 a request to transmit another code set, the processor 140 may transmit another code set among a plurality of code sets to the remote control apparatus 200 through the communicator 120.

Meanwhile, when another code set is received from the display apparatus 100, the processor 240 may control the transmitter 220 to transmit a mute signal based on the received code set to the audio output apparatus 300.

Thereafter, after the processor 240 transmits the mute signal based on another code set to the audio output apparatus 300, the processor 240 may collect the audio signal through the microphone 210 and determine whether or not the audio signal outputted from the apparatus 300 is present in the audio signal received through the microphone 210 to determine whether or not the audio output apparatus 300 is outputting the audio signal, and subsequently determine whether or not another code set corresponds to a code set capable of controlling the audio output apparatus 300.

In this manner, the processor 240 may repeat the process described above until it 240 detects a code set capable of controlling the audio output apparatus 300, and set the remote control apparatus 200 to control the audio output apparatus 300.

Meanwhile, in the examples described above, the display apparatus 100 stores a plurality of code sets, but this is merely an example.

That is, the remote control apparatus 200 may be already stored with a plurality of code sets, and may transmit a mute signal based on the code set to the audio output apparatus 300 according to a control command received from the display apparatus 100.

Specifically, the processor 140 may transmit a control command to transmit a mute signal according to the code set to the remote control apparatus 200 through the communicator 120.

In this case, the processor 240 may transmit a mute signal based on one of a plurality of code sets to the audio output apparatus 300, according to the control command received from the display apparatus 100.

Meanwhile, when the remote control apparatus 200 stores a plurality of code sets, the remote control apparatus 200 may determines whether or not the audio output apparatus 300 is outputting an audio signal to determine a code set capable of controlling the audio output apparatus 300, even in the absence of a control command received from the display apparatus 100.

Specifically, the display apparatus 100 may transmit an audio signal to the audio output apparatus 300, and the audio output apparatus 300 may output the audio signal received from the display apparatus 100.

In this case, the processor 240 may collect an audio signal through the microphone 210, and when an audio signal is received through the microphone 210, transmit a mute signal based on one of a plurality of code sets to the audio output apparatus 300.

Thereafter, the processor 240 may collect the audio signal through the microphone, and determine whether or not the audio signal outputted from the audio output apparatus 300 is present in the audio signal collected through the microphone 210 to thus determine whether or not the code set used for transmitting the mute signal is a code set capable of controlling the audio output apparatus 300.

Specifically, the processor 240 may determine whether or not the code set used for transmitting the mute signal is a code set capable of controlling the audio output apparatus 300, based on presence or absence of a test tone signal in the audio signal collected through the microphone 210. In this case, information on the test tone signal may be provided from the display apparatus 100.

Specifically, when the test tone signal is detected from the audio signal collected through the microphone 210, the processor 240 may determine that the audio signal outputted from the audio output apparatus 300 is present in the audio signal collected through the microphone 210, and, as a result, the processor 240 may determine that the audio output apparatus 300 is outputting the audio signal.

However, when the test tone signal is not detected from the audio signal collected through the microphone 210, the processor 240 may determine that the audio signal outputted from the audio output apparatus 300 is not present in the audio signal collected through the microphone 210, and, as a result, the processor 240 may determine that the audio output apparatus 300 is not outputting the audio signal.

Meanwhile, when it is determined that the audio output apparatus 300 is not outputting the audio signal, the processor 240 may set the remote control apparatus 200 based on the code set used for transmitting the mute signal. In this case, the processor 240 may transmit, to the display apparatus 100 through the communicator 220, a message indicating that setting is done with the code set capable of controlling the audio output apparatus 300.

Accordingly, the remote control apparatus 200 is able to control the audio output apparatus 300.

However, when it is determined that the audio output apparatus 300 is outputting the audio signal, the processor 240 may transmit the mute signal based on another code set to the audio output apparatus 300.

Further, after the processor 240 transmits the mute signal based on another code set to the audio output apparatus 300, the processor 240 may collect the audio signal through the microphone 210 and determine whether or not the audio signal outputted from the apparatus 300 is present in the audio signal received through the microphone 210 to determine whether or not the audio output apparatus 300 is outputting the audio signal, and subsequently determine whether or not another code set corresponds to a code set capable of controlling the audio output apparatus 300.

In this manner, the processor 240 may repeat the process described above until it 240 detects a code set capable of controlling the audio output apparatus 300, and set the remote control apparatus 200 to control the audio output apparatus 300.

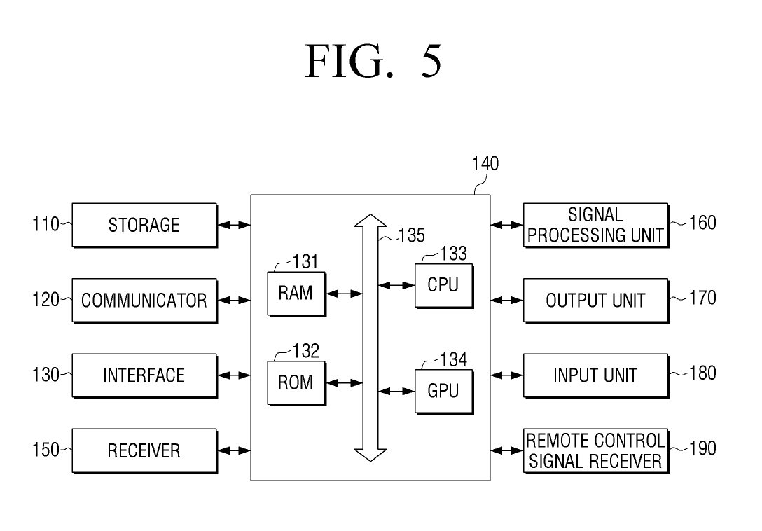

FIG. 5 is a block diagram provided to explain a detailed configuration of a display apparatus according to an embodiment of the present disclosure.

Referring to FIG. 5, the display apparatus 100 may further include a receiver 150, a signal processing unit 160, an output unit 170, an input unit 180, and a remote control apparatus signal receiver 190, in addition to the components shown in FIG. 2, in which the operation of these components may be controlled by the processor 140.

The storage 110 may store an operating system (OS) for controlling overall operation of the electronic device 100, 05) and command or data relating to the components of the display apparatus 100.

Accordingly, the processor 140 may drive an operating system to control multiple hardware or software components connected to the processor 140, and may load command or data received from at least one of the other components onto the volatile memory, and store various data on a non-volatile memory.

To this end, the processor 140 includes a RAM 141, a ROM 142, a CPU 143, a GPU 144 and a bus 145.

The RAM 131, the ROM 132, the CPU 143, the GPU 144, etc. may be connected to each other through the bus 145.

The CPU 143 accesses the storage 110 and performs booting using the O/S stored in the storage 110. In addition, various operations are performed using various programs, contents, data, etc. stored in the storage 110.

The ROM 142 stores an instructions set for booting the system and so on. Upon powering-on in response to input of turn-on command, the CPU 143 copies RAM 141 stored in the storage 110 onto the RAM 141 according to the instructions stored in the ROM 142, and executes the O/S to boot the system. When the booting is completed, the CPU 143 copies various application programs stored in the storage 110 onto the RAM 141, and executes the application program copied to the RAM 141 to perform various operations.

Meanwhile, the GPU 144 generates graphic user interface (GUI) to be provided to a user. The GUI may be added to the image processed by the signal processing unit 160.

The receiver 150 may receive broadcast content (or broadcast signals). The broadcast content may include video, audio, and additional data (e.g., EPG), and the receiver 150 may receive broadcast content from various sources such as terrestrial broadcast, cable broadcast, satellite broadcast, Internet broadcast and so on.

For example, the receiver 150 may be implemented as a form that includes configuration such as a tuner (not shown), a demodulator (not shown), an equalizer (not shown), and so on, in order to receive broadcast content transmitted from a broadcasting station.

The signal processing unit 160 performs signal processing of the content received through the receiver 150 or the interface 130. Specifically, the signal processing unit 160 performs an operation such as decoding, scaling, and frame rate conversion and the like for an image constituting the content, and may perform signal processing into a form that can be outputted from a display (not shown) of the output unit 170. In addition, the signal processing unit 160 may perform signal processing such as decoding and the like for the audio constituting the content, and perform signal processing into a form that can be outputted from an audio output unit (not shown) of the output unit 170.

The output unit 170 may include a display (not shown) for displaying an image outputted from the signal processing unit 160, and an audio output unit (not shown) for outputting audio outputted from the signal processing unit 160.

In this case, the display (not shown) may be implemented as the Liquid Crystal Display (LCD), the Organic Light Emitting Diodes (OLED) display and so on, and an audio output unit (not shown) may be implemented as a speaker (not shown), an external output terminal (not shown) and so on.

The input unit 180 receives various user commands. The processor 140 may execute a function corresponding to the user command inputted from the input unit 180.

For example, the input unit 180 may receive a user command for performing a channel change, a volume control, and so on, and the processor 140 may change a channel or adjust a volume according to the inputted user command.

To this end, the input unit 180 may be implemented as an input panel. The input panel may be provided in a form of a key pad or a touch screen having a touch pad or various function keys, numeric keys, special keys, and character keys and so on.

The remote control apparatus signal receiver 190 receives a control signal inputted from the remote control apparatus 200.

In this case, the remote control apparatus signal receiver 190 may receive various IR-type control signals. For example, the remote control apparatus signal receiver 195 may receive a control signal for performing channel change, volume control, and so on, and the processor 140 may change the channel of the display apparatus 100 or adjust the volume according to the received control signal.

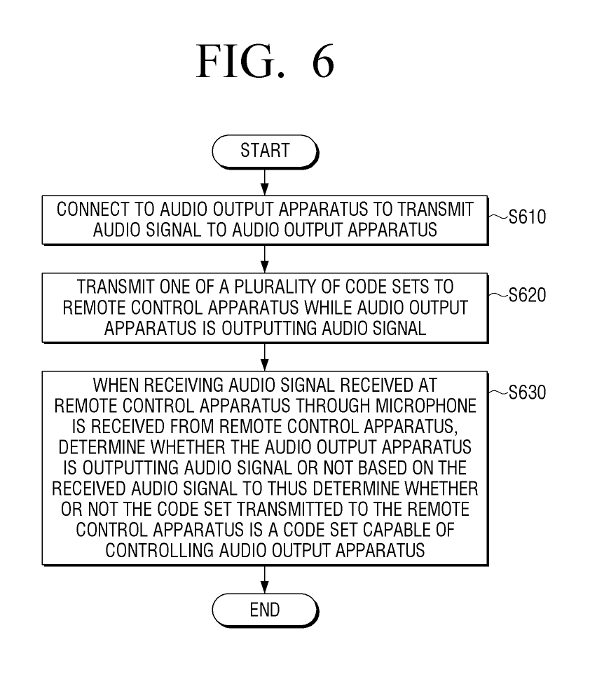

FIG. 6 is a flowchart provided to explain a method for setting a remote control apparatus of a display apparatus according to an embodiment of the present disclosure.

In one example, the display apparatus is connected to an audio output apparatus, and may perform communication with a remote control apparatus having a microphone.

First, an audio signal is transmitted to the audio output apparatus, at S610. In this case, a test tone signal may be added to the audio signal transmitted to the audio output apparatus.

Thereafter, one of a plurality of code sets may be transmitted to the remote control apparatus while the audio output apparatus is outputting the audio signal, at S620. In this case, when the remote control apparatus receives the code set from the display apparatus, the remote control apparatus may transmit a mute signal based on the received code set to the audio output apparatus.

In addition, when the remote control apparatus receives an audio signal received through the microphone from the remote control apparatus, it may be determined as to whether the audio output apparatus is outputting an audio signal based on the received audio signal, to thus determine whether the code set transmitted to the remote control apparatus is a code set capable of controlling the audio output apparatus, at S630.

Meanwhile, if the audio output apparatus is not outputting the audio signal, it may be determined that the code set transmitted to the remote control apparatus is a code set for controlling the audio output apparatus.

Meanwhile, if the audio output apparatus is outputting the audio signal, another one of a plurality of code sets may be transmitted to the remote control apparatus, and when an audio signal received at the remote control apparatus through the microphone is received from the remote control apparatus, it may be determined as to whether the audio output apparatus is outputting the audio signal or not based on the received audio signal, to thus determine whether or not another code set transmitted to the remote control apparatus is a code set capable of controlling the audio output apparatus.

In this case, when the remote control apparatus receives another code set from the display apparatus, the remote control apparatus may transmit a mute signal based on the received code set to the audio output apparatus.

Meanwhile, after transmitting the code set to the remote control apparatus, it may be determined as to whether the audio output apparatus is outputting the audio signal based on whether or not the test tone signal is present in the audio signal received from the remote control apparatus 200.

Meanwhile, a method is already described above, according to which a code set capable of controlling an audio output apparatus is determined using an audio signal outputted from an audio output apparatus, and a remote control apparatus is set accordingly.

A non-transitory computer readable medium may be provided, in which a program for sequentially performing the setting method according to the present disclosure is stored.

The non-transitory computer readable medium is a medium capable of storing data semi-permanently and being readable by a device, rather than a medium such as register, cash, and memory that stores the data for a brief period of time. In particular, the various applications or programs described above may be stored and provided on a non-transitory computer readable medium such as CD, DVD, hard disk, Blu-ray disk, USB, memory card, ROM, and so on.

In addition, although a bus is not shown in the block diagram described above with respect to the display apparatus and the remote control apparatus, the communication between the respective components in the display apparatus and the remote control apparatus may be performed through the bus. In addition, the display apparatus and the remote control apparatus may further include a processor such as a CPU, a microprocessor, and so on for performing the various steps described above.

Further, while the present disclosure has been described in detail above, it should be understood that the detailed description and specific examples, while indicating preferred embodiments of the disclosure, are given by way of illustration only, since various changes and modifications within the scope of the disclosure will become apparent to those skilled in the art from this detailed description.

What is claimed is:

1. A display apparatus, comprising:
a storage configured to store a plurality of code sets;
a communicator configured to perform communication with a remote control apparatus having a microphone;
an interface connected to an audio output apparatus and configured to transmit a first audio signal to the audio output apparatus; and
a processor configured to transmit one of the plurality of code sets to the remote control apparatus while the audio output apparatus is outputting the audio signal, and in response to a second audio signal received at the remote control apparatus through the microphone being received from the remote control apparatus, and determine whether the code set transmitted to the remote control apparatus is capable of controlling the audio output apparatus by determining whether the audio output apparatus is outputting the first audio signal based on the received audio signal.

2. The display apparatus of claim 1, wherein, when the audio output apparatus is not outputting the first audio signal, the processor is configured to determine that the code set transmitted to the remote control apparatus is for controlling the audio output apparatus.

3. The display apparatus of claim 1, wherein, when the audio output apparatus is outputting the first audio signal, the processor is configured transmit another one of the plurality of code sets to the remote control apparatus, and in response to the second audio signal received at the remote control apparatus through the microphone being received from the remote control apparatus, determine whether the another code set transmitted to the remote control apparatus is capable of controlling the audio output apparatus by determining whether the audio output apparatus is outputting the second audio signal based on the received audio signal.

4. The display apparatus of claim 1, wherein the processor is configured to add a test tone signal to the second audio signal transmitted to the audio output apparatus.

5. The display apparatus of claim 4, wherein, after transmitting the code set to the remote control apparatus, the processor is configured to determine whether the audio output apparatus is outputting the first audio signal based on whether the test tone signal is included in the second audio signal received from the remote control apparatus.

6. A method for setting a remote control apparatus of a display apparatus, wherein the display apparatus is connected to an audio output apparatus and configured to perform communication with the remote control apparatus having a microphone, the method comprising:
transmitting a first audio signal to the audio output apparatus;
transmitting one of a plurality of code sets to the remote control apparatus while the audio output apparatus is outputting the first audio signal; and
in response to receiving a second audio signal received at the remote control apparatus through the microphone from the remote control apparatus, determining whether the code set transmitted to the remote control apparatus is capable of controlling the audio output apparatus by determining whether the audio output apparatus is outputting the first audio signal based on the received audio signal.

7. The method of claim 6, wherein the determining comprises, when the audio output apparatus is not outputting the first audio signal, determining that the code set transmitted to the remote control apparatus is for controlling the audio output apparatus.

8. The method of claim 6, further comprising:
when the audio output apparatus is outputting the first audio signal, transmitting another one of the plurality of code sets to the remote control apparatus; and
in response to receiving an audio signal received at the remote control apparatus through the microphone from the remote control apparatus, determining whether the another code set transmitted to the remote control apparatus is capable of controlling the audio output apparatus by determining whether the audio output apparatus is outputting the audio signal based on the received audio signal.

9. The method of claim 6, wherein the transmitting the audio signal comprises adding a test tone signal to the second audio signal transmitted to the audio output apparatus.

10. The method of claim 9, further comprising after transmitting the code set to the remote control apparatus, determining whether the audio output apparatus is outputting the first audio signal based on whether the test tone signal is included in the second audio signal received from the remote control apparatus.

11. An audio system comprising a display apparatus, an audio output apparatus and a remote control apparatus, wherein:
the audio output apparatus is configured to output a first audio signal received from the display apparatus;
the display apparatus is configured to transmit one of a plurality of code sets to the remote control apparatus while the audio output apparatus is outputting the first audio signal; and
the remote control apparatus has a microphone and is configured to transmit a control signal based on the code set received from the display apparatus to the audio output apparatus,
wherein, after the remote control apparatus transmits the control signal, in response to receiving a second audio signal received through the microphone from the remote control apparatus, the display apparatus determines whether the code set transmitted to the remote control apparatus is capable of controlling the audio output apparatus by determining whether the audio output apparatus is outputting the first audio signal based on the received audio signal.
